(19) United States
(12) Patent Application Publication
(10) Pub. No.: US 2012/0239597 A1
(43) Pub. Date: Sep. 20, 2012

(54) METHOD, APPARATUS AND COMPUTER PROGRAM PRODUCT FOR PROVIDING EVIDENCE-BASED CLINICAL DECISION SUPPORT THAT IS WORKFLOW ENVIRONMENT INDEPENDENT

(75) Inventor: Neel Lakshminarayan, Norwood, MA (US)

(73) Assignee: McKesson Financial Holdings

(21) Appl. No.: 13/049,177

(22) Filed: Mar. 16, 2011

(51) Int. Cl. G06N 5/02

(52) U.S. Cl. 706/11

(57) ABSTRACT

A method for providing evidence-based clinical decision support that can be provided independent of any particular workflow environment may include providing evidence-based decision support content defining a set of rules for patient care where the evidence-based decision support content is provided independent of a predefined workflow, providing a set of application programming interfaces (APIs) that enable native application access to the evidence-based decision support content, and providing an integrator that, in connection with processing circuitry, executes instructions to utilize the set of APIs to enable building a user interface for workflow that allows access to the evidence-based decision support content. A corresponding computer program product and apparatus are also provided.

### TECHNOLOGICAL FIELD

Embodiments of the present invention relate generally to solutions for providing evidence-based clinical decision support and, more particularly, relate to a mechanism for providing evidence-based clinical decision support that can be used independent of any particular workflow environment or platform.

### BACKGROUND

Many aspects of the provision of medical care and the management of many aspects of the healthcare system now involve the use of computers and computer applications. For example, recent efforts have been made to move to electronic medical records (EMR). With clinical documentation systems moving to electronic media, clinical data may be available for incorporation into a number of different applications designed to assist in the management or use of such data. Computerized provider order entry (CPOE) is another example of a development that may improve the ability to electronically access information related to physician's orders. Many other applications are also being developed to utilize electronic information on people and processes to manage the provision of various aspects of patient care including the provision of predictive care.

As is to be expected, the demand for applications that can be used for streamlining the provision of health care services and the management of health care-related information has led to the development of many new applications by many different providers. However, these applications are often very specific to certain organizations and to certain tasks. As such, certain functionalities may be tied to specific workflow environments, and it may be difficult to extract the functionality from the specific workflow environment. When these situations arise, the development of proprietary solutions that work only in a specific workflow environment tend to inhibit interoperability and increase overall costs within a system.

### BRIEF SUMMARY

A method, apparatus and computer program product are therefore provided to enable the provision of evidence-based clinical decision support that can be provided independent of any particular workflow environment. For example, some embodiments may provide an evidence-based clinical decision support component or evidence-based decision support system that is enabled to support any native application or workflow environment. Accordingly, a evidence-based clinical decision support component may be provided without any predefined graphical user interface limitations so that native rendering may instead be supported.

In one example embodiment, a method for providing evidence-based clinical decision support that can be provided independent of any particular workflow environment is provided. The method may include providing evidence-based decision support content defining a set of rules for patient care where the evidence-based decision support content is provided independent of a predefined workflow, providing a set of application programming interfaces (APIs) that enable native application access to the evidence-based decision support content, and providing an integrator that, in connection with processing circuitry, executes instructions to utilize the set of APIs to enable building a user interface for workflow that allows access to the evidence-based decision support content.

In another example embodiment, a computer program product for providing evidence-based clinical decision support that can be provided independent of any particular workflow environment is provided. The computer program product may include at least one computer-readable storage medium having computer-executable program code instructions stored therein. The computer-executable program code instructions may include program code instructions for providing evidence-based decision support content defining a set of rules for patient care where the evidence-based decision support content is provided independent of a predefined workflow, providing a set of application programming interfaces (APIs) that enable native application access to the evidence-based decision support content, and providing an integrator that, in connection with processing circuitry, executes instructions to utilize the set of APIs to enable building a user interface for workflow that allows access to the evidence-based decision support content.

In another example embodiment, an apparatus for providing evidence-based clinical decision support that can be provided independent of any particular workflow environment is provided. The apparatus may include processing circuitry. The processing circuitry may be configured for providing evidence-based decision support content defining a set of rules for patient care where the evidence-based decision support content is provided independent of a predefined workflow, providing a set of application programming interfaces (APIs) that enable native application access to the evidence-based decision support content, and providing an integrator that, in connection with processing circuitry, executes instructions to utilize the set of APIs to enable building a user interface for workflow that allows access to the evidence-based decision support content.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for use in connection with providing evidence-based clinical decision support that can be provided independent of any particular workflow environment according to an example embodiment of the present invention;

FIG. 2 is a block diagram showing various components that may be included in an apparatus for providing evidence-based clinical decision support that can be provided independent of any particular workflow environment according to an example embodiment of the present invention;

FIG. 3 is a block diagram according to an example method for providing evidence-based clinical decision support that can be provided independent of any particular workflow environment according to an example embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, some embodiments of the present invention are aimed at providing a mechanism by which to provide evidence-based clinical decision support that can be provided independent of any particular workflow environment. Evidence-based clinical decision support has been around in some form or another for many years. For example, some form of publication describing a set of rules to determine proper care has been around in paper form long before the current move to electronic media began. InterQual® is an example of an electronic version of such an evidence-based clinical decision support application that was designed to deliver sets of protocols to assist practitioners in making decisions and justifying actions taken in relation to such things as determining how long to keep a patient in the hospital after a particular operation based on clinical evidence. However, a common characteristic of software that has provided evidence-based clinical decision support has been an inextricable link to a particular workflow.

As stated above, many healthcare systems and entities use widely varying tools to handle patient data and process electronic data regarding patients and patient visits. The details as to how patient information is entered into and utilized by a particular system define the workflow for the system. For example, details on how patient information is entered into a program may be defined by the application of certain rules that define the workflow for the program. These workflows may be unique to different healthcare providers and thus, any an evidence-based clinical decision support that has been provided by electronic means has typically needed to be specifically tailored to the workflow of the corresponding program or application with which the evidence-based clinical decision support tool is to be utilized. Thus, an evidence-based clinical decision support application developed for one environment may not be used in connection with a different environment since the workflows for each environment and the native rendering employed in each environment may be different.

Example embodiments of the present invention may enable the provision of a evidence-based clinical decision support component that can be provided in a workflow independent manner. Thus, for example, some example embodiments may enable an evidence-based clinical decision support application to be defined without reliance on any particular workflow or predefined graphical user interface. Thus, native rendering may be supported for any workflow environment. In other words, some example embodiments may separate the evidence-based clinical decision support component from workflow in order to deliver a library of evidence-based clinical decision support data that can be used with any application regardless of the workflow requirements of the applications involved. In this regard, some example embodiments may package a evidence-based clinical decision support component that is workflow environment independent into a component that can be delivered to and utilized in any workflow environment or application.

The component may be delivered a evidence-based clinical decision support component comprising evidence-based clinical decision support content as a library of data that can be tailored to any workflow. The evidence-based clinical decision support content and workflow support information may be provided via a set of application programming interfaces (APIs). The APIs may enable an integrator to access the evidence-based clinical decision support component without inhibiting native rendering. Thus, evidence-based clinical decision support content and workflow may be delivered to the integrator via the APIs. The integrator may then be enabled to access evidence based clinical decision support powered by the evidence-based clinical decision support content, develop a workflow without limitation, and access and deploy customized clinical content derived from the evidence-based clinical decision support content.

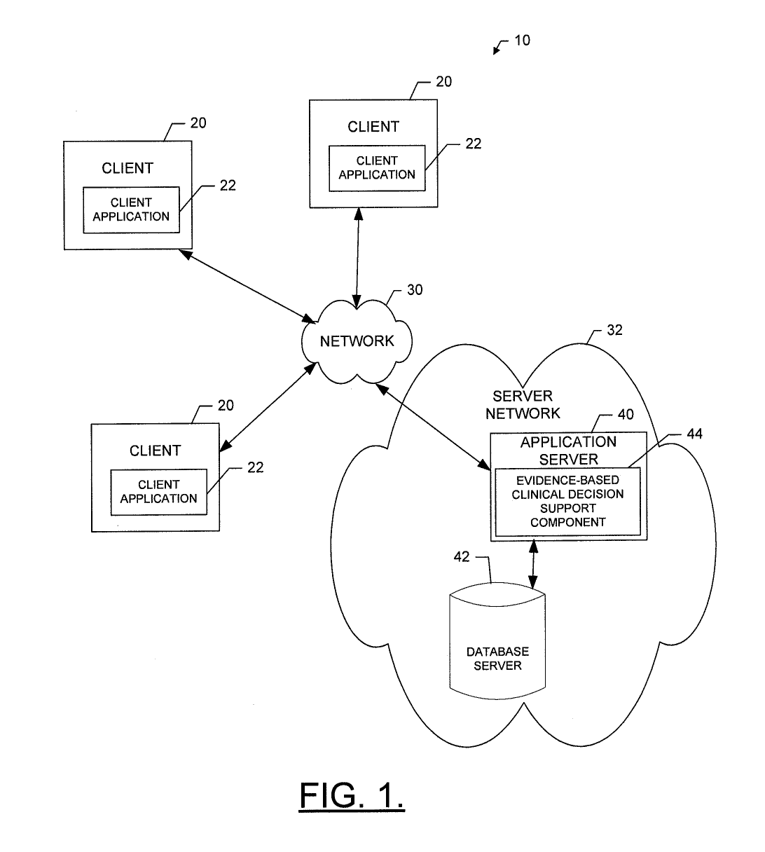

An example embodiment of the invention will now be described in reference to FIG. 1, which illustrates an example system in which an embodiment of the present invention may be employed. As shown in FIG. 1, a system 10 according to an example embodiment may include one or more clients 20 that may, in some cases, be associated with different corresponding healthcare related entities associated with one or more healthcare organizations or systems. For example, one client 20 may be associated with a first facility and a second client 20 may be associated with a second facility. The facilities (and the corresponding clients) may be within the same healthcare organization or system or the facilities could be associated with different healthcare organizations or systems. As such, in some cases, multiple clients may be associated with the same organization.

Each client 20 may be, for example, a computer (e.g., a personal computer, laptop computer, network access terminal, or the like) or may be another form of computing device (e.g., a personal digital assistant (PDA), cellular phone, smart phone, or the like) capable of communication with a network 30. As such, for example, each client 20 may include (or otherwise have access to) memory for storing instructions or applications for the performance of various functions and a corresponding processor for executing stored instructions or applications. Each client 20 may also include software and/or corresponding hardware for enabling the performance of the respective functions of the clients as described below. In an example embodiment, one or more of the clients 20 may include a client application 22 configured to operate in accordance with an example embodiment of the present invention. In this regard, for example, the client application 22 may include software for enabling a respective one of the clients 20 to communicate with the network 30 for requesting and/or receiving a evidence-based clinical decision support component in the form of a deliverable component (e.g., as downloadable software to configure the client, or as a transferable memory device including instructions to configure the client). As such, for example, the client application 22 may include corresponding executable instructions for configuring the client 20 to provide corresponding functionalities as described in greater detail below.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) or databases. Communication between the network 30, the clients 20 and the devices or databases (e.g., servers) to which the clients 20 are coupled may be accomplished by either wireline or wireless communication mechanisms and corresponding protocols.

In an example embodiment, one of the devices to which the clients 20 may be coupled via the network 30 may include one or more application servers (e.g., application server 40), and/or a database server 42, which together may form respective elements of a server network 32. Although the application server 40 and the database server 42 are each referred to as “servers,” this does not necessarily imply that they are embodied on separate servers or devices. As such, for example, a single server or device may include both entities and the database server 42 could merely be represented by a database or group of databases physically located on the same server or device as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an example embodiment, one function that may be provided by the application server 40 may be the provision of a evidence-based clinical decision support component or the provision of services provided by a evidence-based clinical decision support component of an example embodiment.

In some embodiments, for example, the application server 40 may therefore include an instance of an evidence-based clinical decision support component 44 comprising stored instructions for handling activities associated with practicing example embodiments as described herein. As such, in some embodiments, the clients 20 may access the evidence-based clinical decision support component 44 online and utilize the services provided thereby. However, it should be appreciated that in other embodiments, the evidence-based clinical decision support component 44 may be provided from the application server 40 (e.g., via download over the network 30) to one or more of the clients 20 to enable recipient clients to instantiate an instance of the evidence-based clinical decision support component 44 for local operation. As yet another example, the evidence-based clinical decision support component 44 may be instantiated at one or more of the clients 20 responsive to downloading instructions from a removable or transferable memory device carrying instructions for instantiating the evidence-based clinical decision support component 44 at the corresponding one or more of the clients 20. In such an example, the network 30 may not be needed or utilized at all. In some embodiments, the evidence-based clinical decision support component 44 may be embodied as a clinical rules engine.

In an example embodiment, the application server 40 may include or have access to memory (e.g., internal memory or the database server 42) for storing instructions or applications for the performance of various functions and a corresponding processor for executing stored instructions or applications. For example, the memory may store an instance of the evidence-based clinical decision support component 44 configured to operate in accordance with an example embodiment of the present invention. In this regard, for example, the evidence-based clinical decision support component 44 may include software for enabling the application server 40 to communicate with the network 30 and/or the clients 20 for the provision and/or receipt of information associated with providing evidence-based clinical decision support content to practitioners independent of any specific workflow.

As such, the environment of FIG. 1 illustrates an example in which provision of evidence-based clinical decision support content without predefined user interface limitations to permit native rendering may be accomplished by a particular entity (namely the evidence-based clinical decision support component 44 residing at the application server 40). However, it should be noted that the evidence-based clinical decision support component 44 could alternatively handle provision of evidence-based clinical decision support content within a single facility. Thus, in some embodiments, the evidence-based clinical decision support component 44 may be embodied at one or more of the clients 20 and, in such an example, the evidence-based clinical decision support component 44 may be configured to handle provision of evidence-based clinical decision support content only for the corresponding facility.

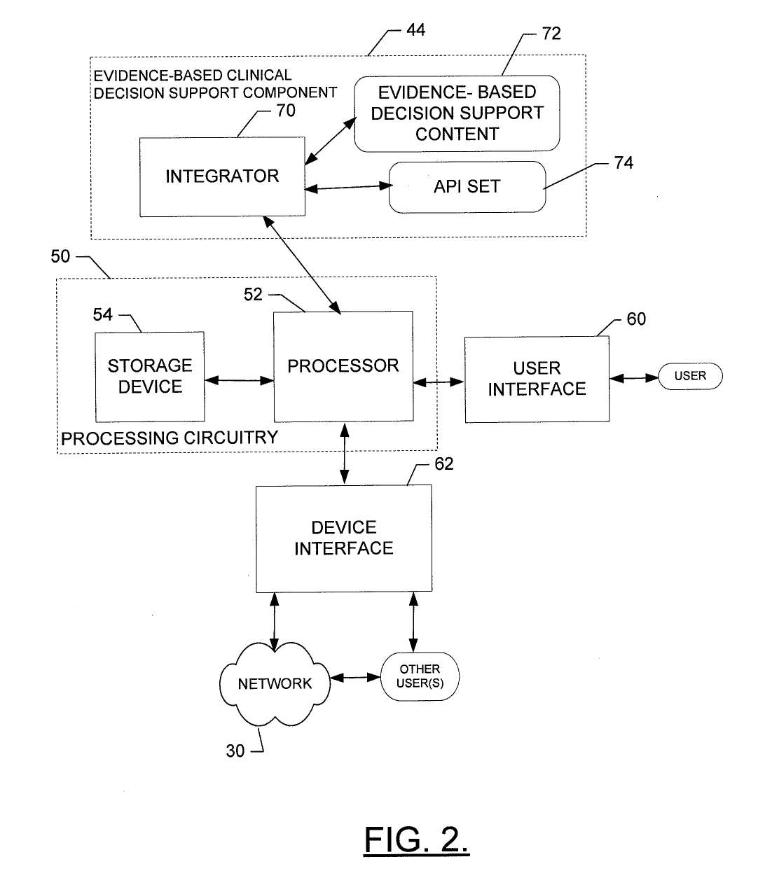

An example embodiment of the invention will now be described with reference to FIG. 2. FIG. 2 shows certain elements of an apparatus for provision of evidence-based clinical decision support content without predefined user interface limitations to permit native rendering according to an example embodiment. The apparatus of FIG. 2 may be employed, for example, on a client (e.g., any of the clients 20 of FIG. 1) or a variety of other devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40 or one or more clients 20) or by devices in a client/server relationship (e.g., the application server 40 and one or more clients 20). Furthermore, it should be noted that the devices or elements described below may not be mandatory and thus some may be omitted in certain embodiments.

Referring now to FIG. 2, an apparatus for provision of evidence-based clinical decision support content without predefined user interface limitations to permit native rendering is provided. The apparatus may include or otherwise be in communication with processing circuitry 50 that is configured to perform data processing, application execution and other processing and management services according to an example embodiment of the present invention. In one embodiment, the processing circuitry 50 may include a processor 52, a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device such as one of the clients 20) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms. In embodiments where the apparatus is embodied at a server or other network entity, the user interface 60 may be limited or even eliminated in some cases.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 54 may include one or more non-transitory storage or memory devices such as, for example, volatile and/or non-volatile memory that may be either fixed or removable. The storage device 54 may be configured to store information, data, applications, instructions or the like for enabling the apparatus to carry out various functions in accordance with example embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., database server 42) that may store a variety of files, contents or data sets. Among the contents of the storage device 54, applications (e.g., client application 22 or evidence-based clinical decision support component 44) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an example embodiment, the processor 52 (or the processing circuitry 50) may be embodied as, include or otherwise control the evidence-based clinical decision support component 44, which may include or otherwise control an integrator 70. The integrator 70 may be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the integrator 70 as described below.

The evidence-based clinical decision support component 44 may also include evidence-based decision support content (e.g., InterQual or other similar content) 72 and an API set 74. The evidence-based decision support content 72 may include the set of rules and protocols developed based on evidence-based clinical data to indicate healthcare standards for various aspects of treatment activities. The API set 74 may provide interfaces to enable the integrator 70 to facilitate native access to the evidence-based decision support content 72. As such, the API set 74 may enable the integrator 70 to enable the building of a user interface for workflow that allows access to the evidence-based decision support content 72, without limiting the workflow to some externally defined workflow. The API set 74 may also enable customization of the evidence-based decision support content 72. The integrator 70 may also enable storage (e.g., in the storage device 54) of review data that is returned by the APIs. Thus, the integrator 70 may be configured to enable interface building to support native access to the evidence-based decision support content 72, enable input to the API set 74 and enable persisting of review data returned by the API set 74. Utilizing the integrator 70, the evidence-based clinical decision support component 44 may be configured to enable parsing of the evidence-based decision support content 72 including any rules associated therewith, enable conduct of workflow utilizing the evidence-based decision support content 72, and generate review results (e.g., recommending services, indicating whether requirements are met or not met, etc.).

The evidence-based clinical decision support component 44 may be developed using any of a number of different technical implementation options. For example, the evidence-based clinical decision support component 44 could be provided via a Java library, via web services, or via a .NET assembly. When provided as a Java library, a set of jar files and an embedded database may be provided to hold clinical content (e.g., evidence-based decision support content 72). The database may be largely transparent to an integrating application and the integrating application may therefore employ the Java library configured to provide the evidence-based clinical decision support component 44 similar to the manner in which other Java libraries are employed. When the evidence-based clinical decision support component is provided as a web service, a war file may be provided and a web server (e.g., the application server 40) and an embedded database (e.g., the database server 42) may be utilized. The war file may expose a set of web services built on top of a Java library such as the Java library discussed above. The database may be largely transparent to the integrating application, which may utilize the evidence-based clinical decision support component 44 as a web service. When provided as a .NET assembly, a set of .NET DLLs and an embedded database may be provided to hold the evidence-based decision support content 72. The database may be largely transparent to the integrating application, which may use the evidence-based clinical decision support component in similar fashion to the manner in which other .NET assemblies are utilized.

The API set 74 may include any number of APIs. However, some example APIs and their corresponding functionalities are provided herein by way of example and not of limitation. In this regard, a GetProducts( . . . ) API may be provided to obtain a list of evidence-based decision support content-related products. A GetSubset( . . . ) API may be provided to obtain a clinical subset. A DoReview( . . . ) API may be provided to initiate or continue a review. A GetNextltem( . . . ) API may be provided to execute a next action in a workflow sequence such as, for example, presenting the next question, criteria, recommendation and/or the like. An ImportCustomizedContent( . . . ) API may be provided to facilitate the import of customized content to the evidence-based clinical decision support component 44. A GetContentForCustomization( . . . ) API may be provided to facilitate download of content for customization to a content editor such as a content customization utility (CCU). As such, the evidence-based clinical decision support component 44 may expose the API set 74 to allow the integrator 70 to customize content using a content editor. Customization APIs may support at least an ability to download content for customization and an ability to import content to the evidence-based clinical decision support component 44.

In an example embodiment, the API set 74 may provide or enable behaviors to be implemented with respect to the evidence-based decision support content 72 to allow the content to be used and enforce control over that usage. Thus, for example, the API set 74 may be tailored to include support for those functions and the specific content that is desired for a given implementation. However, one of the clients 20 may utilize the API set 74 differently than how other clients 20 utilize the API set 74 since each client may have a different use in mind. For example, one client may only need level of care (LOC) content and another client may instead add or only have care planning content. The API set 74 may also permit flexibility to support multiple content formats. Thus, for example, different mobile platforms, fixed computing platforms, applications and/or operating systems may be supported in various different example embodiments.

Business data associated with any usage at a client may be segregated, so that only evidence-based decision support content 72 is stored in connection with the evidence-based clinical decision support component 44. Moreover, in an example embodiment, the evidence-based clinical decision support component 44 may not include or exchange any patient health information so that no patient identifiers are used by the evidence-based clinical decision support component 44. Thus, the evidence-based clinical decision support component 44 may be secure. Content versioning may also be provided so that updates and reviews between updates may be supported.

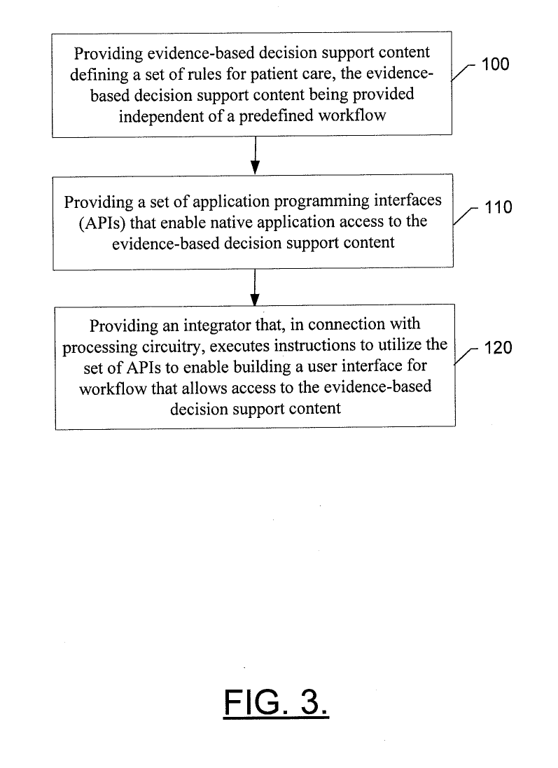

Embodiments of the present invention may therefore be practiced using an apparatus such as the one depicted in FIG. 2. However, other embodiments may be practiced in connection with a computer program product for performing embodiments of the present invention. FIG. 3 is a flowchart of a method and program product according to example embodiments of the invention. Each block or step of the flowchart of FIG. 3, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s). These computer program instructions may also be stored in a non-transitory computer-readable storage medium comprising memory that may direct a computer or other programmable apparatus to function in a particular manner, such that the instructions stored in the computer-readable memory produce an article of manufacture including instructions to implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

In this regard, a method according to one embodiment of the invention, as shown in FIG. 3, may include providing evidence-based decision support content defining a set of rules for patient care where the evidence-based decision support content is provided independent of a predefined workflow at operation 100. The rules for patient care may include protocols for treatment, support for care-related decision making processes and/or support for determinations regarding the appropriateness of care. The method may further include providing a set of application programming interfaces (APIs) that enable native application access to the evidence-based decision support content at operation 110, and providing an integrator that, in connection with processing circuitry, executes instructions to utilize the set of APIs to enable building a user interface for workflow that allows access to the evidence-based decision support content at operation 120.

In some cases, the method may include additional optional operations. Any additional operations, and/or modifications to the operations above or the additional operations, may be performed in addition to the operations described above in any order and in any combination. Thus, in some embodiments, all of the additional operations or modifications may be practiced, while in others none of the additional operations or modifications may be practiced. In still other embodiments, any combination of less than all of the additional operations or modifications may be practiced. In an example embodiment, building the user interface may include building the user interface to allow access to the evidence-based decision support content via workflow defined by the native application. In some embodiments, one or more of providing the evidence-based decision support content, providing the set of APIs and providing the integrator may include providing the evidence-based decision support content, providing the set of APIs or providing the integrator via a Java library, via web services, or via a .NET assembly. Thus, in some cases, a Java library may be transferred to a receiving or client device to implement an example embodiment. However, in other cases, web services or a .NET assembly may be employed to instantiate an example embodiment. In some cases, providing the integrator may include providing the integrator to enable storage of review data returned by the set of APIs. In an example embodiment, providing the integrator may include providing the integrator to enable generation of review results defining recommended services based on the evidence-based decision support content. In some embodiments, providing the integrator may include providing the integrator to enable generation of review results indicating requirement satisfaction relative to the evidence-based decision support content. In an example embodiment, providing the integrator further may include providing the integrator to enable customization of content using a content editor. Other modifications are also possible. The modifications and optional operations may be included in any combination and in any order with respect to the operations 100-120 described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing evidence-based decision support content defining a set of rules for patient care, the evidence-based decision support content being provided independent of a predefined workflow;
providing a set of application programming interfaces (APIs) that enable native application access to the evidence-based decision support content; and
providing an integrator that, in connection with processing circuitry, executes instructions to utilize the set of APIs to enable building a user interface for workflow that allows access to the evidence-based decision support content.

2. The method of claim 1, wherein building the user interface comprises building the user interface to allow access to the evidence-based decision support content via workflow defined by the native application.

3. The method of claim 1, wherein one or more of providing the evidence-based decision support content, providing the set of APIs and providing the integrator comprises providing the evidence-based decision support content, providing the set of APIs or providing the integrator via a Java library, via web services, or via a .NET assembly.

4. The method of claim 1, wherein providing the integrator further comprises providing the integrator to enable storage of review data returned by the set of APIs.

5. The method of claim 1, wherein providing the integrator further comprises providing the integrator to enable generation of review results defining recommended services based on the evidence-based decision support content.

6. The method of claim 1, wherein providing the integrator further comprises providing the integrator to enable generation of review results indicating requirement satisfaction relative to the evidence-based decision support content.

7. The method of claim 1, wherein providing the integrator further comprises providing the integrator to enable customization of content using a content editor.

8. An apparatus comprising processing circuitry configured to:
provide evidence-based decision support content defining a set of rules for patient care, the evidence-based decision support content being provided independent of a predefined workflow;
provide a set of application programming interfaces (APIs) that enable native application access to the evidence-based decision support content; and
provide an integrator that executes instructions to utilize the set of APIs to enable building a user interface for workflow that allows access to the evidence-based decision support content.

9. The apparatus of claim 8, wherein the processing circuitry being configured to build the user interface comprises the processing circuitry being configured to build the user interface to allow access to the evidence-based decision support content via workflow defined by the native application.

10. The apparatus of claim 8, wherein the processing circuitry being configured to provide one or more of the evidence-based decision support content, the set of APIs and the integrator comprises the processing circuitry being configured to provide the evidence-based decision support content, the set of APIs or the integrator via a Java library, via web services, or via a .NET assembly.

11. The apparatus of claim 8, wherein the processing circuitry being configured to provide the integrator further comprises the processing circuitry being configured to provide the integrator to enable storage of review data returned by the set of APIs.

12. The apparatus of claim 8, wherein the processing circuitry being configured to provide the integrator further comprises the processing circuitry being configured to provide the integrator to enable generation of review results defining recommended services based on the evidence-based decision support content.

13. The apparatus of claim 8, wherein the processing circuitry being configured to provide the integrator further comprises the processing circuitry being configured to provide the integrator to enable generation of review results indicating requirement satisfaction relative to the evidence-based decision support content.

14. The apparatus of claim 8, wherein the processing circuitry being configured to provide the integrator further comprises the processing circuitry being configured to provide the integrator to enable customization of content using a content editor.

15. A computer program product comprising at least one computer-readable storage medium having computer-executable program code instructions stored therein, the computer-executable program code instructions comprising program code instructions for:
providing evidence-based decision support content defining a set of rules for patient care, the evidence-based decision support content being provided independent of a predefined workflow;
providing a set of application programming interfaces (APIs) that enable native application access to the evidence-based decision support content; and
providing an integrator that executes instructions to utilize the set of APIs to enable building a user interface for workflow that allows access to the evidence-based decision support content.

16. The computer program product of claim 15, wherein program code instructions for building the user interface includes instructions for building the user interface to allow access to the evidence-based decision support content via workflow defined by the native application.

17. The computer program product of claim 15, wherein program code instructions for one or more of providing the evidence-based decision support content, providing the set of APIs and providing the integrator includes instructions for providing the evidence-based decision support content, providing the set of APIs or providing the integrator via a Java library, via web services, or via a .NET assembly.

18. The computer program product of claim 15, wherein program code instructions for providing the integrator includes instructions for providing the integrator to enable storage of review data returned by the set of APIs.

19. The computer program product of claim 15, wherein program code instructions for providing the integrator includes instructions for providing the integrator to enable generation of review results defining recommended services based on the evidence-based decision support content or indicating requirement satisfaction relative to the evidence-based decision support content.

20. The computer program product of claim 15, wherein program code instructions for providing the integrator includes instructions for providing the integrator to enable customization of content using a content editor.
